(19) United States
(12) Patent Application Publication
(10) Pub. No.: US 2025/0311879 A1
(43) Pub. Date: Oct. 9, 2025

(54) CENTRIFUGAL COFFEE EXTRACTION

(71) Applicant: 87 North Enterprises, LLC, Saratoga Springs, NY (US)

(72) Inventors: Kyle Brock, Queensbury, NY (US); E. Ryan Miller, Lake George, NY (US)

(73) Assignee: 87 North Enterprises, LLC, Saratoga Springs, NY (US)

(21) Appl. No.: 19/247,051

(22) Filed: Jun. 24, 2025

Related U.S. Application Data
(63) Continuation-in-part of application No. 18/833,575, filed on Jul. 26, 2024, now Pat. No. 12,364,357.
(60) Provisional application No. 63/476,716, filed on Dec. 22, 2022.

(51) Int. Cl. A47J 31/22; A23F 5/26

(52) U.S. Cl. CPC A47J 31/22; A23F 5/26

(57) ABSTRACT

A coffee extraction apparatus includes: a housing with an exterior wall extending between a lower end and an upper end, wherein the lower end defines a sump; a basket disposed within the housing and mounted for rotation about an axis, the basket including a plurality of openings sized to permit the passage of liquid therethrough while preventing the passage of solids above a predetermined size; a driver operable to spin the basket about the axis; a supply of an inert gas; and means for purging the housing with the inert gas from the gas supply.

### BACKGROUND OF THE INVENTION

This invention relates generally to coffee extraction and more particularly to cold brew processes.

Coffee is produced by roasting and grinding coffee beans to produce coffee grounds. The grounds are contacted with water that is heated (and sometimes pressurized) to extract flavor compounds from the grounds, resulting in a finished beverage.

So-called “cold brew” coffees are becoming more popular. Cold brew coffee differs from conventional hot-brewed coffee in that the water is supplied at relatively low temperature. Compared to hot-brewed coffee, cold brew coffee typically has a lower acidity and a greater concentration of caffeine. In prior art practice, extraction of cold brew coffee requires that the coffee grounds be contacted with water over an extended period of time, typically hours or days.

### BRIEF SUMMARY OF THE INVENTION

This shortcoming of the prior art is addressed by the technology described herein, which describes an apparatus and method for extraction of cold brew coffee.

According to one aspect of the technology described herein, a coffee extraction apparatus includes: a housing with an exterior wall extending between a lower end and an upper end, wherein the lower end defines a sump; a basket disposed within the housing and mounted for rotation about an axis, the basket including a plurality of openings sized to permit the passage of liquid therethrough while preventing the passage of solids above a predetermined size; a driver operable to spin the basket about the axis; a supply of an inert gas; and means for purging the housing with the inert gas from the gas supply. According to another aspect of the technology described herein, a method of producing cold brew coffee includes: using air flow to load coffee grounds from a supply container into an extraction apparatus, the apparatus including: a housing with an exterior wall extending between a lower end and an upper end, wherein the lower end defines a sump; a basket disposed within the housing and mounted for rotation about an axis, the basket including a plurality of openings sized to permit the passage of liquid therethrough while preventing the passage of solids above a predetermined size; and a driver operable to spin the basket about the axis; introducing water at a temperature of substantially less than 98 degrees Celsius into the basket; using the driver to rotate the basket, thereby forcing the water through the coffee grounds, producing cold brew coffee which collects in the sump.

According to another aspect of the technology described herein, a method of producing cold brew coffee includes: loading coffee grounds into an extraction apparatus, the apparatus including: a housing with an exterior wall extending between a lower end and an upper end, wherein the lower end defines a sump; a basket disposed within the housing and mounted for rotation about an axis, the basket including a plurality of openings sized to permit the passage of liquid therethrough while preventing the passage of solids above a predetermined size; and a driver operable to spin the basket about the axis; introducing water at a temperature of substantially less than 98 degrees Celsius into the basket; purging the interior of the housing with an inert gas; and using the driver to rotate the basket, thereby forcing the water through the coffee grounds, producing cold brew coffee which collects in the sump.

### BRIEF DESCRIPTION OF THE DRAWINGS

The invention may be best understood by reference to the following description taken in conjunction with the accompanying drawing figures, in which:

FIG. 1 is a schematic, partially-sectioned side view of an exemplary centrifuge; and

FIG. 2 is a view of the centrifuge of FIG. 1 with coffee grounds loaded therein;

FIG. 3 is a view of the centrifuge of FIG. 1 along with a vacuum loading apparatus, showing coffee grounds being loaded; and

FIG. 4 is a view of the centrifuge of FIG. 1 along with a mechanical loading apparatus.

### DETAILED DESCRIPTION OF THE INVENTION

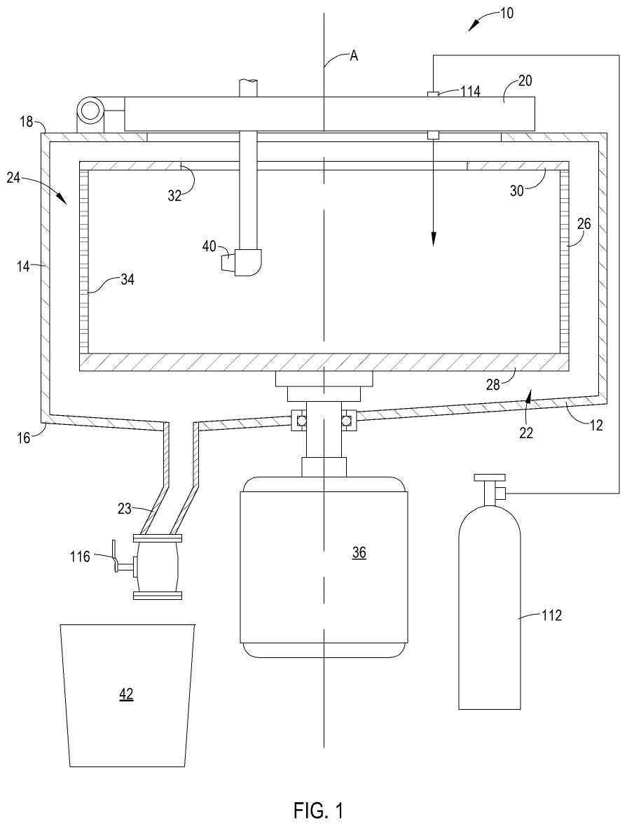

Referring to the drawings wherein identical reference numerals denote the same elements throughout the various views, FIG. 1 illustrates a centrifuge 10 which may be used to produce a cold brew coffee beverage.

The centrifuge 10 includes a housing 12 with an exterior wall 14 extending between a lower end 16 and an upper end 18. The upper end 18 may be closed off by a movable cover 20. The lower end 16 defines a sump 22 which is sloped towards an outlet pipe 23.

A basket 24 is disposed within the housing 12 and mounted for rotation about an axis “A”. In the illustrated example, the basket 24 is generally cylindrical and includes an annular peripheral wall 26 extending between a bottom plate 28 and a top plate 30. The top plate 30 includes a central feed opening 32. Optionally, the top plate 30 may be detachable from the remainder of the basket 24. For example, it could be coupled to the peripheral wall 26 using threaded fasteners, tabs, pins, or latches (not shown).

The peripheral wall 26 includes a plurality of openings 34 such as holes, slots, perforations, or orifices. The size of the openings 34, their shape, spacing, total number and total open area may be selected to suit a particular application. Typically, the openings are sized to permit the passage of liquid therethrough while preventing the passage of solids above a certain predetermined size. Optionally, a screen (not shown) may be positioned around the interior of the peripheral wall 26. The openings in the screen may be smaller than the openings 34 in the peripheral wall 26.

The basket 24 is mechanically coupled to a driver 36. The driver 36 is operable to spin the basket 24 about axis A at a desired rotational speed (RPM). The centripetal acceleration produced by the centrifuge (measured in G units) depends upon the rotational speed of the basket 24 and the diameter of the basket 24. Commercially available centrifuges are capable of producing accelerations in the range of 800 to 2000 G. This acceleration is colloquially referred to as “centrifugal force”. It has the effect of strongly pressing any material within the basket 24 against the inner surface of the peripheral wall 26. If the basket 24 contains solids of various sizes or a combination of solids and liquids, the effect of the centrifuge 10 is to retain the solids against the inner surface of the peripheral wall 26, while forcing liquids or small-sized solids through the openings 34. They then fall into the sump 22 and collect by gravity at the location of the outlet pipe 23.

Typically, centrifuges are used to remove liquid in order to produce a dry end product. Alternatively, a centrifuge may be used to force water through coffee grounds to extract flavor compounds at low temperatures, thus effectively producing a cold brew beverage.

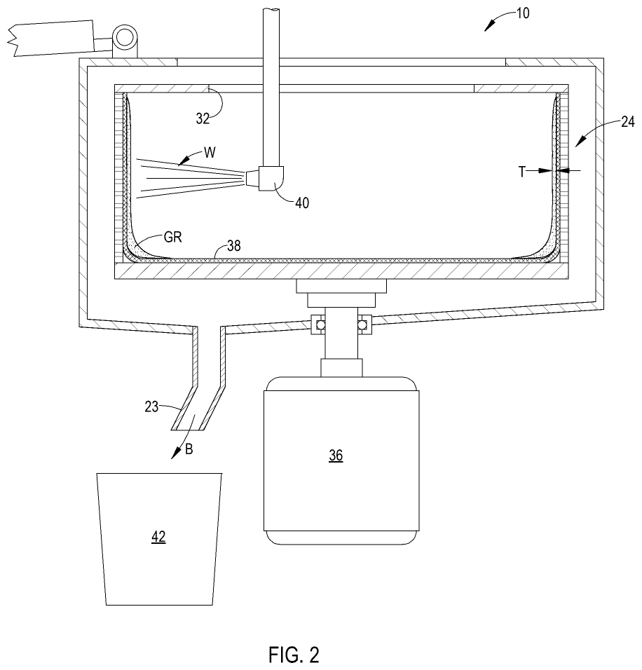

Referring to FIG. 2, in one example process, the basket 24 is started into rotation and coffee grounds “GR” are loaded into the basket through the feed opening 32. In one sequence, the grounds GR are loaded while the basket 24 is stationary, then rotation is started. Alternatively, rotation may be started and then grounds GR may be introduced through the feed opening 32. The second method has been found to result in a more even distribution of the grounds GR against the peripheral wall, that is, a thickness “T” of the grounds is generally the same over the distance between the bottom plate 28 and the top plate 30. However, this method may require a user to place body parts near the moving basket. In either case, the grounds GR may be redistributed if necessary, using an appropriate tool such as a scraper (not shown). The grounds GR may be introduced in either a dry form or a pre-wetted (slurry) form.

Optionally, the grounds GR may be loaded into a filter bag 38 which is placed into the basket 24. This provides a convenient means of cleaning the basket 24, as the entire filter bag 38 with the spent grounds GR therein may simply be removed at the end of the extraction process. The filter bag 38 may be used instead of the screen described above. Optionally, the filter bag 38 may be connected to the top plate 30. This could permit easier removal of the used filter bag 38, especially in combination with a detachable top plate 30.

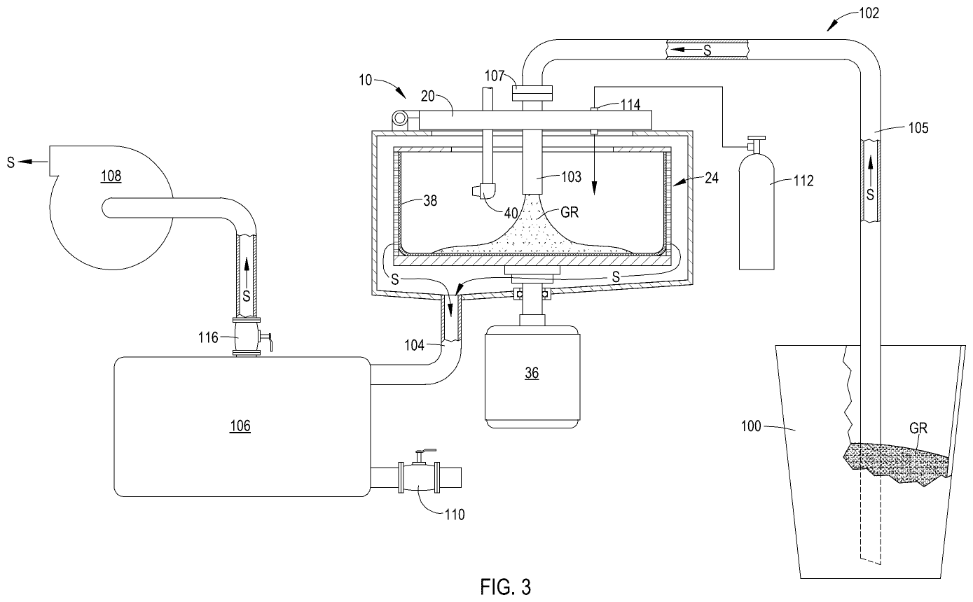

Once the basket 24 is operating at a desired rotational speed with the grounds GR loaded, an appropriate solvent (for example water “W”) is introduced into the basket 24. As shown in FIG. 2, water W may be introduced by spraying it through a nozzle 40 towards the grounds GR. Optionally, the spray nozzle 40 may pass through the lid 20 as shown in FIGS. 1 and 3. Operation of the centrifuge 10 forces the water W through the coffee grounds GR, extracting flavor compounds. Because of the action of the centrifuge 10, there is no need for the water W to be supplied at any particular pressure or velocity.

The water W may be supplied at any temperature. However, the centrifuge 10 is especially useful for producing “cold brew coffee”. It is generally accepted that “cold brew” refers to any extraction temperature at ambient room temperature and below. In contrast, hot brewed coffee is typically extracted at approximately 98 degrees Celsius. Accordingly, for this process, the water W may be at substantially less than 98 degrees Celsius. In one example, the water W may have a maximum temperature of approximately 23 degrees Celsius. The centrifuge 10 is effective to produce a cold brew beverage in the amount of time it takes for the water W to flow through the coffee grounds GR in a single pass through the device. This would typically be a matter of a few seconds from leaving the nozzle 40 to being collected as an end product. Enough water is added through nozzle 40 to reach the desired yield volume and desired content of total dissolved solids (TDS) in the finished product.

Optionally, the rotational speed of basket 24 may be varied. It may spin at a slow rate when loading to allow a pre-infusion of water as the grounds GR form the cake having a relatively even distribution of the grounds GR against the peripheral wall, that is, a thickness “T” of the grounds. Once all loaded there is a steep time where the spin rate is slow enough not to pull all of the water through the grounds GR. Then after the steep time the speed may be increased (example, about 800 rpm) and more water introduced through the spray nozzle 40 which gets pulled through the grounds GR very quickly along with any residual water from the loading process.

The water W with dissolved flavor compounds constitutes a beverage “B”, namely, cold brew coffee, which falls into the sump 22 and collects by gravity at the outlet pipe 23. This is collected in a container 42. It is then ready for further processing, such as the addition of flavorings and/or packaging. In one example, the beverage B produced directly from the centrifuge 10 would be in a concentrated form that may be diluted with water or other liquid to produce a beverage ready for consumption. Dilution may be performed by the manufacturer prior to packaging, or by the end consumer.

The extraction process above has been described using a manual batch loading process for the grounds GR. Alternatively, the grounds GR may be loaded into the basket 24 using a flow transfer process. Referring to FIG. 3, a supply container 100, such as a simple open hopper, is loaded with dry grounds GR. A loading pipe 102 extends between the supply container 100 and the closed cover 20. Appropriate seals (not illustrated) would be provided to prevent air leakage between the cover 20 and the housing 12. In the illustrated example, the loading pipe 102 includes a first portion 103 extending through and permanently mounted to the cover 20, coupled to a second portion 105 at a joint 107. This permits the second portion 105 to be removed when not in use.

An outlet pipe 104 extends between the housing 12 and a collection container 106.

A vacuum source 108 such as a vacuum cleaner (e.g. shop-type vacuum or similar) is coupled to the collection container 106. Beginning with an empty basket 24, the vacuum source 108 is turned on, creating a partial vacuum in the housing 12 and the basket 24, generating a suction air flow (arrows “S”) and the basket 24 is rotated. This would be at a slow speed such as 10% of top speed. This causes the grounds GR to be drawn into the basket 24 through the loading pipe 102. The slow-speed spinning distributes the grounds GR up the sides of the basket 24 in an even layer, into the shape seen in FIG. 2. This continues until the desired amount of grounds GR are loaded. Subsequently, water spray is introduced through nozzle 40 and the extraction process proceeds as described above. The finished beverage may be drained from the collection container through a drain valve 110.

As a possible alternative, the air flow for dry grounds loading could be reversed. Specifically, the grounds GR could be moved from a sealed supply container (not shown) into the housing 12 by pressurizing the supply container.

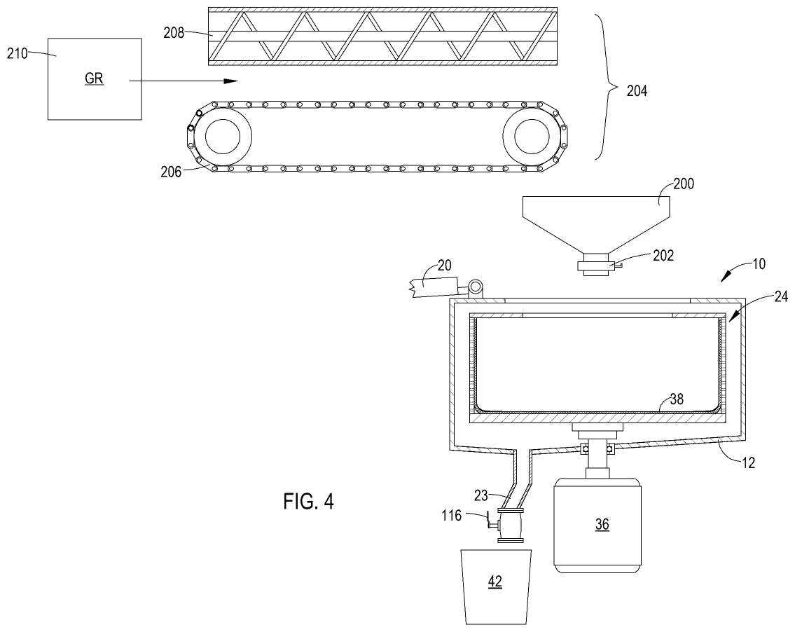

Alternatively, the grounds GR may be loaded into the basket 24 using a mechanical loading apparatus. Referring to FIG. 4, a loading hopper 200 with a valve 202 that can be selectively moved between an open position and a closed position is positioned above the basket 24. A conveyer 204 such as the illustrated belt conveyor 206 or auger conveyor 208 is provided and is operable to transfer dry grounds GR from a bulk storage container 210 (shown schematically) to the loading hopper 200.

Beginning with an empty basket 24, the loading hopper valve 202 is opened allowing grounds GR to fall by gravity into the basket 24. During or before this process, the loading hopper 200 is filled as required by the conveyor 204. The basket 24 is rotated at a slow speed such as 10% of top speed. The slow-speed spinning distributes the grounds GR up the sides of the basket 24 in an even layer, into the shape seen in FIG. 2. This continues until the desired amount of grounds GR are loaded. Subsequently, water spray is introduced through nozzle 40 and the extraction process proceeds as described above. The finished beverage may be drained from the collection container through outlet pipe 23.

The presence of oxygen rapidly deteriorates the flavors and shelf life of coffee. Therefore, optionally, for any of the loading processes described above, the housing 12 may be purged with a gas to exclude oxygen during the extraction process, subsequent to the grounds GR being loaded and prior to the extraction process. Referring to FIG. 3, a gas supply 112 such as a pressurized cylinder may be provided. In one example, the gas may be an inert gas such as nitrogen or argon. The gas supply 112 is coupled by a line to a port 114 which communicates with the interior of the housing 12. A vent valve 116 may be provided downstream of the housing 12, for example between the collection container 106 and the vacuum source 108. The vent valve 116 is movable between an open position and a closed position.

The gas purge process may proceed as follows: the dry grounds GR are loaded using the vacuum flow process described above. Gas from the gas supply 112 is introduced to the port 114. It fills the housing 12, expelling any oxygen through outlet pipe 104, the collection container 106, and the vacuum source 108 to atmosphere. Once the complete system has been purged, for example by allowing gas to flow for several seconds, the vent by 116 may be closed to avoid loss of purge gas. By removing all environmental air from the system and replacing with an inert gas such as pure nitrogen or argon, the amount of dissolved oxygen in the final product after extraction is greatly reduced.

The main advantage of the concept described herein is the use of dry ground coffee loaded into the centrifuge prior to extraction with ambient temperature water. By dry loading the coffee, it more closely mirrors the espresso method of extracting coffee. During espresso extraction, freshly ground coffee is tamped into a metal filtering device. Water is then introduced under positive steam pressure through those grounds. The grind of the coffee is very fine (˜280 microns). The method described herein can also start with a similarly fine grind for the coffee that tamped under centrifugal pressure and water is forced through using this same angular momentum pressure.

The foregoing has described an apparatus and method for producing cold brew coffee. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A coffee extraction apparatus, comprising:
a housing with an exterior wall extending between a lower end and an upper end, wherein the lower end defines a sump;
a basket disposed within the housing and mounted for rotation about an axis, the basket including a plurality of openings sized to permit the passage of liquid therethrough while preventing the passage of solids above a predetermined size;
a driver operable to spin the basket about the axis;
a supply of an inert gas; and
means for purging the housing with the inert gas from the gas supply.

2. The apparatus of claim 1, further comprising a vent valve in fluid communication with the housing, positioned downstream of the gas supply.

3. The apparatus of claim 1, further comprising:
a supply container configured to be loaded with dry coffee grounds;
a loading pipe extending between the supply container and the housing; and
means for generating an air flow from the supply container through the loading pipe into the housing.

4. The apparatus of claim 3, wherein the loading pipe includes a first portion extending through and permanently mounted to the cover, coupled to a second portion at a joint.

5. The apparatus of claim 3, wherein the means for generating an air flow comprise:
an outlet pipe extending between the housing and a collection container; and
a vacuum source coupled to the collection container.

6. The apparatus of claim 1, wherein the supply container is an open hopper.

7. The apparatus of claim 1, wherein the basket is generally cylindrical and includes an annular peripheral wall extending between a bottom plate and a top plate, the top plate includes a central feed opening, and the plurality of openings are formed in the peripheral wall.

8. The apparatus of claim 1, further comprising a filter bag disposed in the basket.

9. The apparatus of claim 1, further comprising a nozzle positioned to spray water into the basket.

10. The apparatus of claim 1, further comprising a movable cover configured to selectively close off the upper end of the housing.

11. The apparatus of claim 1, further comprising:
a loading hopper positioned above the housing;
a bulk storage container; and
a conveyer configured to transfer dry grounds from the bulk storage container to the hopper.

12. A method of producing cold brew coffee, comprising:
loading coffee grounds into an extraction apparatus, the apparatus including:
a housing with an exterior wall extending between a lower end and an upper end, wherein the lower end defines a sump;
a basket disposed within the housing and mounted for rotation about an axis, the basket including a plurality of openings sized to permit the passage of liquid therethrough while preventing the passage of solids above a predetermined size; and
a driver operable to spin the basket about the axis;
introducing water at a temperature of substantially less than 98 degrees Celsius into the basket;
purging the interior of the housing with an inert gas; and
using the driver to rotate the basket, thereby forcing the water through the coffee grounds, producing cold brew coffee which collects in the sump.

13. The method of claim 12, further comprising loading the coffee grounds by using air flow to move coffee grounds from a supply container into the extraction apparatus.

14. The method of claim 12, wherein the water introduced has a maximum temperature of approximately 23 degrees Celsius.

15. The method of claim 12, wherein the air flow is created by pressurizing the supply container.

16. The method of claim 12, wherein the air flow is created using apparatus comprising:
a loading pipe extending between the supply container and the housing;
an outlet pipe extending between the housing and a collection container; and
a vacuum source coupled to the collection container.

17. The method of claim 12, wherein the basket is generally cylindrical and includes an annular peripheral wall extending between a bottom plate and a top plate, the top plate includes a central feed opening, and the plurality of openings are formed in the peripheral wall.

18. The method of claim 12, further comprising placing a filter bag in the basket before loading the coffee grounds into the apparatus.

19. The method of claim 12, wherein the water is introduced by using a nozzle to spray water into the basket.

20. The method of claim 12, further comprising loading the coffee grounds by using a conveyer to transfer dry grounds from a bulk storage container to a loading hopper positioned above the housing.
